(19) United States
(12) Patent Application Publication
(10) Pub. No.: US 2023/0408069 A1
(43) Pub. Date: Dec. 21, 2023

(54) SMART CANDLE LAMP

(71) Applicant: Dongguan LianRun Lighting Co., Ltd., Dongguan (CN)

(72) Inventor: Kunpeng Chen, Dongguan (CN)

(21) Appl. No.: 18/459,510

(22) Filed: Sep. 1, 2023

(30) Foreign Application Priority Data
Aug. 22, 2023 (CN) 202322253191.X

(51) Int. Cl. F21V 17/14; F21S 6/00

(52) U.S. Cl. CPC F21V 17/14; F21S 6/001

(57) ABSTRACT

The present disclosure relates to the technical field of candle lamps, and discloses a smart candle lamp. A candle lamp body includes an outer lamp housing and a base arranged at a bottom of the outer lamp housing; a bottom surface of the base is connected with an insulating bottom plate; the candle lamp body is further provided with a wire guide hole for allowing a wire to be threaded out; the smart candle lamp further includes a lamp; the lamp includes a lamp holder and a bulb; the lamp holder is mounted on an inner side of a top of the outer lamp housing; the lamp holder is electrically connected to a first electrical wire; a printed circuit board (PCB) is further arranged in the outer lamp housing; one end of the PCB is electrically connected to the first electrical wire.

### TECHNICAL FIELD

The present disclosure relates to the technical field of candle lamps, and in particular, to a smart candle lamp.

### BACKGROUND

Candle lamps, also referred to as novel smokeless candle lamps, have a similar appearance to real candles, but will not generate smoke or carcinogens, making an environment cleaner, more hygienic, and tidier. The candle lamps can not only be used for lighting but also to add atmosphere, so the candle lamps are widely applied to window displaying and decorative lighting to create an elegant atmosphere in restaurants and bar tables, or to family gatherings at night.

A traditional candle lamp includes a lamp fixedly mounted at a top and has a regular line arrangement. Many components need to arranged in the lamp. This often leads to a complex overall structure of the lamp and high preparation costs and is not conducive to production. On the other hand, a base of the candle lamp is usually formed of a metal material. To reduce the production costs and facilitate assembling of internal components of the lamp, a bottom of the lamp is usually not sealed. However, direct contact between an internal component of the candle lamp and an object such as a tabletop can easily lead to accidents such as electric leakage. This setting method has low safety performance and does not comply with existing usage standards. To solve the above problems, the inventor has made a new invention.

### SUMMARY

The present disclosure aims to overcome the shortcomings in the prior art and provide a smart candle lamp, which has the characteristics of simple structure, low cost, and high safety.

In order to achieve the above objective, the present disclosure discloses a smart candle lamp, including a candle lamp body; the candle lamp body includes an outer lamp housing and a base arranged at a bottom of the outer lamp housing; a bottom surface of the base is connected with an insulating bottom plate; the candle lamp body is further provided with a wire guide hole for allowing a wire to be threaded out; the smart candle lamp further comprises a lamp; the lamp includes a lamp holder and a bulb; the lamp holder is mounted on an inner side of a top of the outer lamp housing; the lamp holder is electrically connected to a first electrical wire; the bulb is electrically connected to the lamp holder and extends out of the top of the outer lamp housing; a printed circuit board (PCB) is further arranged in the outer lamp housing; one end of the PCB is electrically connected to the first electrical wire, and the other end is electrically connected with a second electrical wire; and the second electrical wire extends out of the wire guide hole and is electrically connected with a male plug.

Further, the bottom surface of the base is provided with at least one group of bulges; and the insulating bottom plate is provided with at least one group of bayonets matched with the bulges.

Further, several convex points are arranged on a circumferential side of the insulating bottom plate.

Further, the insulating bottom plate is adhered to the base or is in tight fit with an inner side of the base.

Preferably, a bottom of the base is sleeved with a gravity center seat.

Much further, an accommodating position is arranged in the middle of the insulating bottom plate, and the base is mounted in the accommodating position.

Preferably, velvet cloth is attached to a bottom surface of the insulating bottom plate.

Further, the wire guide hole is formed in a side wall of the base; the second electrical wire extends into the base and is threaded out of the wire guide hole; and the wire guide hole is further sleeved with a rubber sleeve.

Further, a portion, close to an inner side of the wire guide hole, of the second electrical wire is provided with a connecting knot; and a width of the connecting knot is greater than a width of the wire guide hole.

Further, a first opening is formed in the top of the outer lamp housing; the lamp holder is in tight fit with an inner wall of the first opening; and a platform portion is further arranged at the first opening.

Beneficial effects: Compared with the prior art, the smart candle lamp of the present disclosure has a simple structure and low preparation cost. The internal PCB achieves intelligent control on the lamp, and the insulating bottom is arranged at the bottom of the lamp to isolate the internal circuit of the lamp from the outside, so that the safety performance of the candle lamp is effectively improved without increasing the assembling difficulty of the lamp.

### BRIEF DESCRIPTION OF THE DRAWINGS

FIG. 1 is a schematic diagram of an overall structure of the present disclosure.

FIG. 2 is a schematic diagram of an internal structure of a candle lamp body of the present disclosure.

FIG. 3 is a schematic structural diagram of a base of the present disclosure.

FIG. 4 is a schematic structural diagram of a first opening of the present disclosure.

FIG. 5 is a schematic structural diagram of an insulating bottom plate of the present disclosure.

Reference numerals include:

1: candle lamp body; 11: wire guide hole; 111: rubber sleeve; 2: outer lamp housing; 21: PCB; 22: first opening; 23: annular clamping block; 24: first elastic sheet; 241: fixed portion; 242: elastic portion; 25: second elastic sheet; 26: platform portion; 3: base; 31: insulating bottom plate; 311: bayonet; 312: accommodating position; 313: velvet cloth; 314: convex point; 32: bulge; 4: lamp; 41: lamp holder; 42: bulb; 43: first electrical wire; 5: second electrical wire; 51: male plug; 6: gravity center seat; and 7: connecting knot.

### DETAILED DESCRIPTION OF THE EMBODIMENTS

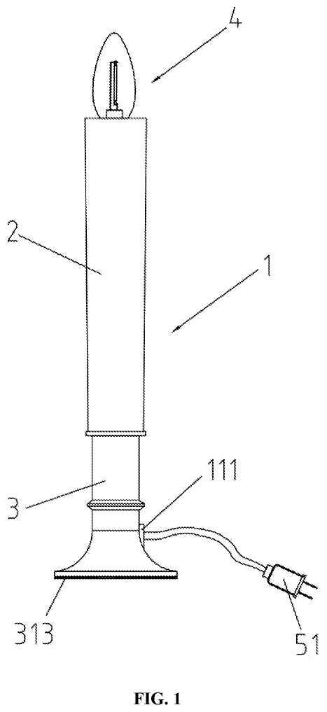

The present disclosure is described in detail below in combination of FIG. 1-FIG. 5.

The present disclosure provides a smart candle lamp, including a candle lamp body 1. The candle lamp body 1 includes an outer lamp housing 2 and a base 3 arranged at a bottom of the outer lamp housing 2. A bottom surface of the base 3 is connected with an insulating bottom plate 31. The candle lamp body 1 is further provided with a wire guide hole 11 for allowing a wire to be threaded out. The smart candle lamp further includes a lamp 4. The lamp 4 includes a lamp holder 41 and a bulb 42. The lamp holder 41 is mounted on an inner side of a top of the outer lamp housing 2. The lamp holder 41 is electrically connected to a first electrical wire 43. The bulb 42 is electrically connected to the lamp holder 41 and extends out of the top of the outer lamp housing 2. A PCB 21 is further arranged in the outer lamp housing 2. One end of the PCB 21 is electrically connected to the first electrical wire 43, and the other end is electrically connected with a second electrical wire 5. The second electrical wire 5 extends out of the wire guide hole 11 and is electrically connected with a male plug 51.

The present disclosure simplifies the structure of the traditional candle lamp, and provides a smart candle lamp with a simpler structure and low preparation cost. The insulating bottom plate 31 is additionally arranged at the bottom, so that circuit elements inside the candle lamp will not be directly exposed to the outside; accidents caused by the candle lamp are effectively avoided; the safety performance of the smart candle lamp is further improved; and the smart candle lamp conforms to the usage specification of the United States UL certification regulations.

In this technical solution, there are various embodiments of connection between the insulating bottom plate 31 and the base 3.

As an embodiment, the bottom surface of the base 3 is provided with at least one group of bulges 32. The insulating bottom plate 31 is provided with at least one group of bayonets 311 matched with the bulges 32. During assembling of the insulating bottom plate 31, the bayonets 311 are aligned with the bulges 32 for direct snap fit to assemble the insulating bottom. The insulating bottom plate 31 can be assembled in a manual or a mechanical automation manner. In this embodiment, the insulating bottom plate 31 is quickly assembled and can be removed for replacement, which is also convenient for internal maintenance of the candle lamp.

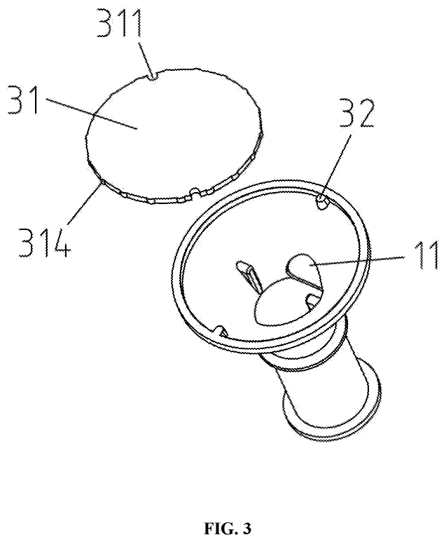

In the above embodiment, as shown in FIG. 3, several convex points 314 are arranged on a circumferential side of the insulating bottom plate 31. Positioning grooves are formed between the several convex points 314. The positioning grooves are convenient for positioning the insulating bottom plate 31 or automatically grasp the insulating bottom plate 31 through a mechanical arm, so as to accelerate the assembling of the insulating bottom plate 31.

As another embodiment, the insulating plate is adhered to the base 3 or is in tight fit with an inner side of the base 3. Adhesion or tight fit does not require additional components, which further simplifies the structure.

In this technical solution, regardless of whether the base 3 is clamped, adhered or tightly fitted to the insulating bottom plate 31, a bottom of the base 3 is sleeved with a gravity center seat 6. The gravity center seat 6 enlarges a contact area between the base 3 and an object such as a tabletop, so that the following phenomenon may be avoided: after the candle lamp is placed, if the bottom of the candle lamp is underweight, the candle lamp will tilt or overturn due to an extremely high gravity center of the candle lamp.

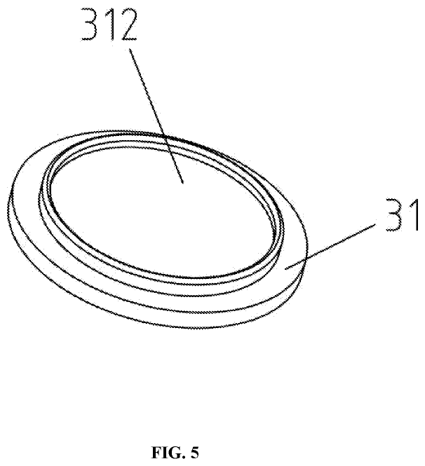

As another embodiment, as shown in FIG. 5, an accommodating position 312 is arranged in the middle of the insulating bottom plate 31, and the base 3 is mounted in the accommodating position 312. In this embodiment, when the insulating bottom plate 31 sleeves an outer side of the base 3, the insulating bottom plate 31 can be used as both an insulating seat and the gravity center seat 6, killing two birds with one stone. The insulating bottom plate can be removed for replacement and has high flexibility and practicality.

As a preferred option, velvet cloth 313 is attached to a bottom surface of the insulating bottom plate 31. The velvet cloth 313 can prevent scratches on an object such as a tabletop and increase friction between the candle lamp and an external object, allowing the candle lamp to be stably placed at a position such as the tabletop.

As an embodiment, the wire guide hole 11 is formed in a side wall of the base 3. The second electrical wire 5 extends into the base 3 and is threaded out of the wire guide hole 11. The candle lamp needs to be connected to a power supply through a wire to achieve powering on, and the wire guide hole 11 is arranged below the candle lamp to minimize the influence of the wire on the overall appearance of the candle lamp. In this technical solution, the wire guide hole 11 is also sleeved with a rubber sleeve 111. The rubber sleeve 111 is formed of soft plastic or a rubber material and has a function of protecting a wire rod to prevent a side wall of the wire guide hole 11 from scratching the second electrical wire 5. In this technical solution, the first electrical wire 43 and the second electrical wire 5 are two-core wires.

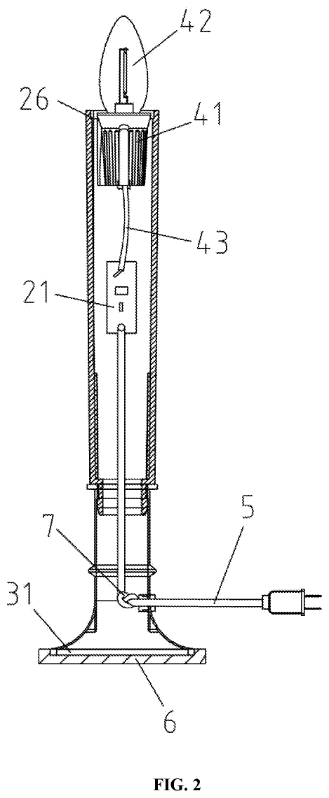

To further improve the technical solution, a portion, close to an inner side of the wire guide hole 11, of the second electrical wire 5 is provided with a connecting knot 7. As shown in FIG. 2, a width of the connecting knot 7 is greater than a width of the wire guide hole 11. When an outer end of the second electrical wire 5 is pulled, the connecting knot 7 can be stuck at an inner end of the wire guide hole 11 to increase tension and prevent damage to the PCB 21 caused by pulling the wires inside the candle lamp body 1.

In this technical solution, there are various embodiments of connection between the outer lamp housing 2 and the base 3, including threaded connection, adhesion, or snap fit.

In the present disclosure, the lamp holder 41 is fixed at the top of the outer lamp housing 2. There are the following several embodiments of fixing of the lamp holder 41.

As an embodiment, a first opening 22 is formed in the top of the outer lamp housing 2. The lamp holder 41 is in tight fit an inner wall of the first opening 22 to fix the position of the lamp holder 41. The first opening 22 is further provided with a platform portion 26. The platform portion 26 limits and controls an assembling position of the lamp holder 41, so that the lamp holder 41 is exactly flush with the position of the first opening 22 after being assembled.

As another embodiment, a first opening 22 is formed in the top of the outer lamp housing 2, and the first opening 22 is provided with a platform portion 26. An annular clamping block 23 is arranged above the platform portion 26. During assembling, a horn-shaped opening of the lamp holder 41 is ultimately fixed between the annular clamping block 23 and the platform portion 26 to achieve overall fixation of the lamp holder 41. In this embodiment, the lamp holder 41 is firmly assembled and will not easily fall off. A side surface of the annular clamping block 23 is inclined from an upper end to a central axis of the first opening 22 in an inverted conical distribution, which has a guide effect of guiding mounting of the lamp holder 41, so as to achieve rapid and smooth assembling of the lamp holder 41.

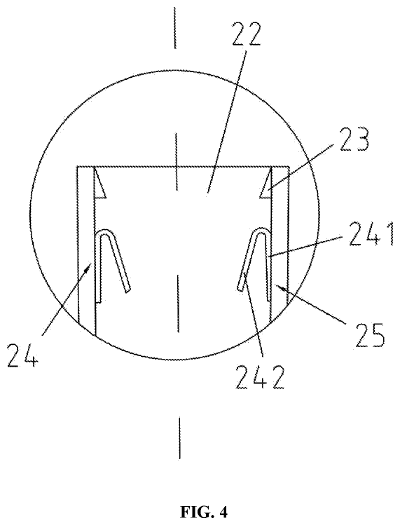

As another embodiment, as shown in FIG. 4, a circular clamping block 23 is arranged at the first opening 22, and a side surface of the annular clamping block 23 is inclined from an upper end to a central axis of the first opening 22 in an inverted conical distribution. A first elastic sheet 24 and a second elastic sheet 25 are symmetrically arranged below the annular clamping block 23. The first elastic sheet 24 and the second elastic sheet 25 each include a fixed portion 241 and an elastic portion 242. The fixed portions 241 are fixedly connected to an inner wall of the outer lamp housing 2, and the elastic portions 242 are slantways distributed from the upper end towards the central axis of the first opening 22. The two elastic portions 242 are used together to limit the position of the lamp holder 41. In this embodiment, the annular clamping block 23 mounted at an opening end of an upper part of the lamp holder 41 is fixed between the first elastic sheet 24 and the second elastic sheet 25. A lower part of the lamp holder 41 is circumferentially fixed by the two elastic portions 242 of the elastic sheets. The two elastic portions 242 form a circumferential supporting force to fix a cylindrical side wall of the lamp holder 41, so that the lamp holder 41 is stably assembled in the outer lamp housing 2, without moving. A quantity of the elastic sheets can be selected according to an actual need.

The above contents are only preferred embodiments of the present disclosure. Those of ordinary skill in the art can make changes to the specific implementations and application scopes according to the idea of the present disclosure, and the contents of this specification shall not be understood as restrictions to the present disclosure.

What is claimed is:

1. A smart candle lamp, comprising a candle lamp body (1), wherein the candle lamp body (1) comprises an outer lamp housing (2) and a base (3) arranged at a bottom of the outer lamp housing (2); a bottom surface of the base (3) is connected with an insulating bottom plate (31); the candle lamp body (1) is further provided with a wire guide hole (11) for allowing a wire to be threaded out; the smart candle lamp further comprises a lamp (4); the lamp (4) comprises a lamp holder (41) and a bulb (42); the lamp holder (41) is mounted on an inner side of a top of the outer lamp housing (2); the lamp holder (41) is electrically connected to a first electrical wire (43); the bulb (42) is electrically connected to the lamp holder (41) and extends out of the top of the outer lamp housing (2); a printed circuit board (PCB) (21) is further arranged in the outer lamp housing (2); one end of the PCB (21) is electrically connected to the first electrical wire (43), and the other end is electrically connected with a second electrical wire (5); and the second electrical wire (5) extends out of the wire guide hole (11) and is electrically connected with a male plug (51).

2. The smart candle lamp according to claim 1, wherein the bottom surface of the base (3) is provided with at least one group of bulges (32); and the insulating bottom plate (31) is provided with at least one group of bayonets (311) matched with the bulges (32).

3. The smart candle lamp according to claim 2, wherein several convex points (314) are arranged on a circumferential side of the insulating bottom plate (31).

4. The smart candle lamp according to claim 1, wherein the insulating bottom plate (31) is adhered to the base (3) or is in tight fit with an inner side of the base (3).

5. The smart candle lamp according to claim 1, wherein a bottom of the base (3) is sleeved with a gravity center seat (6).

6. The smart candle lamp according to claim 1, wherein an accommodating position (312) is arranged in the middle of the insulating bottom plate (31), and the base (3) is mounted in the accommodating position (312).

7. The smart candle lamp according to claim 1, wherein velvet cloth (313) is attached to a bottom surface of the insulating bottom plate (31).

8. The smart candle lamp according to claim 1, wherein the wire guide hole (11) is formed in a side wall of the base (3); the second electrical wire (5) extends into the base (3) and is threaded out of the wire guide hole (11); and the wire guide hole (11) is further sleeved with a rubber sleeve (111).

9. The smart candle lamp according to claim 1, wherein a portion, close to an inner side of the wire guide hole (11), of the second electrical wire (5) is provided with a connecting knot (7); and a width of the connecting knot (7) is greater than a width of the wire guide hole (11).

10. The smart candle lamp according to claim 1, wherein a first opening (22) is formed in the top of the outer lamp housing (2); the lamp holder (41) is in tight fit with an inner wall of the first opening (22); and a platform portion (26) is further arranged at the first opening (41).
